(19) United States
(12) Patent Application Publication
(10) Pub. No.: US 2021/0056220 A1
(43) Pub. Date: Feb. 25, 2021

(54) METHOD FOR IMPROVING CONFIDENTIALITY PROTECTION OF NEURAL NETWORK MODEL

(71) Applicant: MEDIATEK Inc., Hsin-Chu (TW)

(72) Inventors: Yi-Min YANG, Hsinchu City (TW); Jia-Hua YANG, Hsinchu City (TW); Chia-Ming LU, Hsinchu City (TW); Cheng-Hsun HSIEH, Hsinchu City (TW)

(21) Appl. No.: 16/868,578

(22) Filed: May 7, 2020

Related U.S. Application Data
(60) Provisional application No. 62/890,101, filed on Aug. 22, 2019.

(51) Int. Cl. G06F 21/62; G06N 3/10

(52) U.S. Cl. CPC G06F 21/6218; G06N 3/10

(57) ABSTRACT

A method applied to an equipment for improving confidentiality protection of neural network model is provided. An operating system of the equipment may comprise a framework and a hardware abstraction layer (HAL), and the method may comprise: before a source model in an application (app) is executed, by a processor of the equipment, modifying the source model to form a modified model by running a modification subroutine associated with the app, and causing the framework to accept the modified model, instead of the source model, as the model to be executed, so the framework instructs the HAL to prepare execution of the modified model.

This application claims the benefit of U.S. provisional application Ser. No. 62/890,101, filed Aug. 22, 2019, the subject matter of which is incorporated herein by reference.

### FIELD OF THE INVENTION

The present invention relates to a method for improving confidentiality protection of neural network (NN) model, and more particularly, to a method protecting confidentiality of NN model by: before a source model in an application (app) is executed, modifying the source model to a modified model, and then causing a framework between the app and a hardware abstraction layer (HAL) to accept the modified model as the model to be executed, so the source model will not be exposed to the framework.

### BACKGROUND OF THE INVENTION

Machine learning based on NN model may solve complicated and difficult problems, such as data regression, time-series prediction, natural language processing, face recognition, object classification and image detection, etc., and therefore becomes popular and essential. An NN model may model a relation between input(s) and output(s) by operation(s) and associated learnable (s), and then be trained by various known input-output sets to compute value of each learnable parameter, e.g., by tuning value of each learnable parameter to fit the known input-output sets. After the value of each learnable parameter is obtained (learned, trained), the resultant trained NN model may be executed to infer (predict) unknown output(s) in response to given input(s). To leverage problem solving capability of NN, a developer can include a trained NN model in an app which may be deployed to and executed on an electronic equipment, such as a smart phone, a portable computer, a wearable gadget, a digital camera, a camcorder, a game console, a smart consumer electronic, an auto guided vehicle or a drone, etc.

Designing and training a NN model involve much knowledge, skill, knowhow, effort and resource; therefore, a resultant trained NN model, including model topology (e.g., number of operations, type of each operation and how operations mutually interconnect) and learned value(s) of learnable parameter(s), is an important intellectual property of the developer, and should be well protected. However, when a trained NN model in an app deployed to an equipment is to be executed, the trained NN model will suffer from undesired exposure to manufacturer (e.g., OBM, own branding & manufacturing) of the equipment. According to conventional NN model handling flow, when the app is launched and initializes a trained model for setting it ready to be executed, the trained NN model will be exposed to a framework (e.g., Android NN framework) interfacing between the app and a HAL, so the framework can then instruct the HAL to prepare execution of the trained NN model by compiling the trained NN model. Because the manufacturer of the equipment has access to the framework, the manufacture can plagiarize the trained NN model against willingness of the developer by dumping information of the framework.

### SUMMARY OF THE INVENTION

An object of the invention is providing a method (e.g., 200 in FIG. 1) applied to an equipment (e.g., 10) for improving confidentiality protection of neural network model. An operating system (e.g., 30) of the equipment may include a framework (e.g., 110) and a hardware abstraction layer (HAL, e.g., 120). The method may include: before a source model (e.g., M1) in an app (e.g., 100) is executed (e.g., when the app initializes the source model to be executed), by a processor (e.g., 20) of the equipment, modifying (e.g., 202) the source model to form a modified model (e.g., M2) by running a modification subroutine (e.g., 102) associated with the app, and causing the framework to accept the modified model, instead of the source model, as the model to be executed, so the framework may instruct the HAL to prepare execution of the modified model.

In an embodiment, the method may further include: by the processor, when the framework instructs the HAL to prepare execution of the modified model, reconstructing (e.g., 204) the source model from the modified model by running a reconstructing subroutine (e.g., 104) in the HAL, and causing the HAL to prepare execution (e.g., 206) of the reconstructed source model. In an embodiment, the method may further include (e.g., 206): when the framework requests the HAL to execute the modified model, causing the HAL to execute the reconstructed source model.

In an embodiment. modifying the source model to form the modified model may include: generating a reconstructing information (e.g., 210 in FIG. 2) which may indicate how to reconstruct the source model from the modified model, encapsulating the reconstructing information into a subset (e.g., d11) of one or more additional operands (e.g., d11 and d12), adding one or more extension operations (e.g., ex0 and ex1) to the modified model, and adding said one or more additional operands to the modified model. In an embodiment, the method may further include: arranging each of said one or more additional operands to be an input or an output of one (e.g., ex1) of said one or more extension operations.

In an embodiment, reconstructing the source model from the modified model may include: identifying said one or more extension operations and accordingly obtaining said one or more additional operands, retrieving the reconstructing information from said one or more additional operands, and building the source model according to the reconstruction information.

In an embodiment, generating the reconstructing information may include: compressing and encrypting the source model to form the reconstructing information. In an embodiment, the method may further include: when the framework instructs the HAL to prepare execution of the modified model, reconstructing the source model from the modified model by retrieving the reconstruction information from the modified model, and decrypting and decompressing the reconstruction information to obtain the source model.

In an embodiment, the source model may include one or more original operations (e.g., n0 to n3 in FIG. 2), one or more operation-input operands (e.g., d0 to d5; d7; d8 and d10) respectively being one or more inputs of said one or more original operations, and one or more model-output operands (e.g., d6 and d9) respectively being one or more outputs of the source model; accordingly, modifying the source model to form the modified model may further include: rearranging said one or more operation-input operands to be one or more inputs of a first subset (e.g., ex0) of said one or more extension operations, and/or rearranging said one or more model-output operands to be one or more outputs of the first subset of said one or more extension operations. In an embodiment, said one or more operation-input operands may include one or more learned operands (e.g., d3, d4 and d10), and modifying the source model to form the modified model may further include; re-dimensioning each of said one or more learned operand to be a scalar. In an embodiment, modifying the source model to form the modified model may also include: discarding a subset (e.g., n0 to n3) of said original operations when forming the modified model from the source model.

An object of the invention is providing a method applied to an equipment (e.g., 10 in FIG. 1) for improving confidentiality protection of neural network model; an operating system (e.g., 30) of the equipment may include a framework (e.g., 110) and a HAL (e.g., 120), and the method may include; when the framework instructs the HAL to prepare execution of a second model (e.g., M2), by a processor of the equipment, causing the HAL to prepare execution of a first model (e.g., M1) different from the second model. In an embodiment, the method may further include: when the framework instructs the HAL to prepare execution of the second model, reconstructing the first model from the second model before causing the HAL to prepare execution of the first model. In an embodiment, the method may further include: before the framework instructs the HAL to prepare execution of the second model, modifying the first model to form the second model.

In an embodiment, the second model may include one or more extension operations (e.g., ex0 and ex1 in FIG. 2), and reconstructing the first model from the second model may include: identifying said one or more extension operations and accordingly obtaining one or more inputs (e.g., d11) of said one or more extension operations, retrieving a reconstructing information (e.g., 210) from said one or more inputs, and building the first model according to the reconstruction information. In an embodiment, the second model may include one or more operands (e.g., d0 to d12), and reconstructing the first model from the second model may include: retrieving a reconstructing information (e.g., 210) from a subset (e.g., d11) of said one or more operands, and decrypting and decompressing the reconstruction information to obtain the first model.

An object of the invention is providing a method applied to an equipment (e.g., 10 in FIG. 1) for improving confidentiality protection of neural network model; an operating system (e.g., 30) of the equipment may include a framework (e.g., 110) and a HAL (e.g., 120), and the method may include: when the framework instructs the HAL to prepare execution of a second model (e.g., M2), if the second model includes one or more extension operations (e.g., ex0 and ex1 in FIG. 2), by a processor (e.g., 20) of the equipment, causing the HAL to prepare execution of a first model (e.g., M1) different from the second model; otherwise, causing the HAL to prepare execution of the second model. In an embodiment, the method may further include: if the second model includes said one or more extension operation, reconstructing the first model from the second model before causing the HAL to prepare execution of the first model. In an embodiment, reconstructing the first model from the second model may include: obtaining a reconstructing information (e.g.; 210) from one or more inputs (e.g.; d11) of said one or more extension operations, and building the first model according to the reconstruction information.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates an NN model handling flow according to an embodiment of the invention; and

FIG. 2 illustrates an example of modifying a source model to a modified model according to an embodiment of the invention.

### DETAILED DESCRIPTION OF PREFERRED EMBODIMENTS

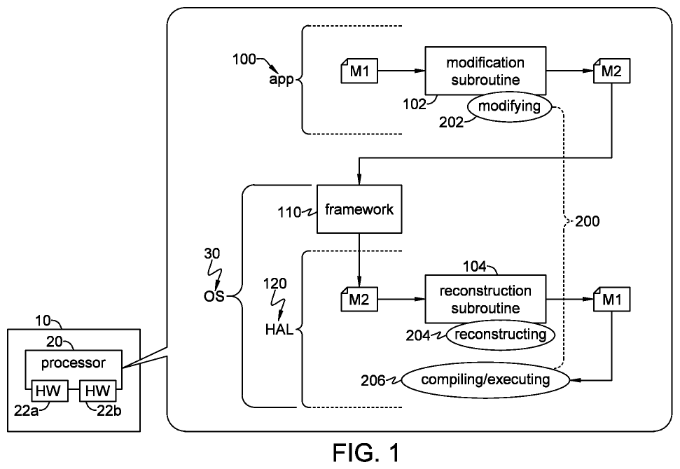

FIG. 1 illustrates an NN model handling flow 200 according to an embodiment of the invention; the flow 200 may be applied to an electronic equipment 10 for improving confidentiality protection of trained NN model, such as a source model M1. The equipment 10 may include a processor (e.g., CPU) 20 which may run apps under an operating system (OS) 30 by one or more hardware devices, such as 22a and 22b; for example, each hardware device may be (or may include) central processing hardware, arithmetic logic hardware, digital signal processing hardware, graphic processing hardware and/or dedicated artificial intelligence processing hardware, etc. Each hardware device may include circuitry integrated within the processor 20, and/or circuitry within a semiconductor chip (not shown) other than processor 20.

To bring inference/prediction capability of NN to the equipment 10, an app 100 including one or more trained source NN models, such as the model M1 in FIG. 1, may be deployed (installed) to the equipment 10 under the OS 30. The app 100 may set the model M1 ready to be executed; collect and feed input(s) to the model M1, trigger the model M1 to be executed on the input(s) to generate output(s), demonstrate the output(s) and/or control the equipment 10 according to the output(s). For example, the app 100 may obtain preliminary input data by interacting with function(s), service(s) and/or other app(s) (not shown) of the OS 30, and/or interacting with peripheral(s) (not shown) of the equipment 10, such as sensor(s), gyroscope, touch panel, keyboard, microphone and/or camera etc.; then the app 100 may process (e.g., quantize, normalize, resample, abstract, partitioning, concatenate, etc.,) the preliminary input data according to acceptable input format of the model M1, so as to form input(s) of the model M1; After executing the model M1 on the input(s) to generate resultant output(s), the app 100 may interact with function(s), service(s) and/or other app(s) of the OS 30, and/or peripheral(s) of the equipment 10 according to the output(s); for example, the app 100 may playback the output(s) by a speaker (not shown) of the equipment 10, display the output(s) on a screen (not shown) of the equipment 10, or control stepper motor(s) (not show) of the equipment 10 according to the output(s), e.g.; for auto piloting.

As shown in FIG. 1, the OS 30 may include a framework 110 and a HAL 120 to facilitate execution of the model M1 For example, the OS 30 may be an Android operating system, and the framework 110 may be an Android NN framework. The HAL 120 may include driver(s) (not shown) of the hardware device(s) (e.g., 22a and 22b). When an NN model including one or more operations is revealed to the framework 110 in order to be prepared for later execution, the framework 110 may interact with the HAL 120 to select a propriate driver for each operation of the NN model according to characteristics of each operation and capability of each driver, and may instruct the selected driver to prepare execution of the corresponding operation by compiling it.

As previously explained, according to conventional NN model handling flow, when an app with a NN model initializes the NN model to set it ready to be executed, the app will directly reveal the NN model to the framework between the app and the HAL, so the framework can select and instruct driver(s) in the HAL to prepare execution of the NN model. However, directly revealing the NN model will compromise confidentiality of the NN model, since equipment manufacturer can dump information of the framework to peek the NN model against willingness of NN model developer.

To overcome the security leakage of the conventional NN model handling flow, the invention provides the NN model handling (preparing and/or executing) flow 200. To implement the invention, the OS 30 may further include a modification subroutine 102 associated with the app 100, and the HAL 120 may further include a reconstruction subroutine 104. For example, the modification subroutine 102 may be included in a library (not shown). The modification subroutine 102 may be called by the app 100 to run upon an original NN model, and may therefore modify the original NN model to form a modified NN model different from the original NN model. In an embodiment; when modifying the original NN model to the modified NN model, the modification subroutine 102 may cause the modified NN model to include one or more predefined extension operations which may not exist in the original NN model. For example, each said extension operation may be a customized operation different from native operations of the framework 110, and may be tailored as a signature of the modification subroutine 102. Hence, if an NN model includes one or more said extension operations, it may be recognized that the NN model has been modified by the modification subroutine 102.

Corresponding to the modification subroutine 102, when the framework 110 instructs the HAL 120 to prepare execution of an exposed NN model, if the exposed NN model include one or more said extension operations, the reconstruction subroutine 104 may be triggered to run; and may therefore form a reconstructed NN model from the exposed NN model; wherein the reconstructed NN model may be different from the exposed NN model. For example, the reconstruction subroutine 104 may be included in an extension driver (not shown) in the HAL 120; said extension driver may inform the framework 110 that the extension driver itself has capability to prepare execution of said extension operation(s). Therefore, when an app reveal an NN model to the framework 110 for setting the NN model ready, if the NN model includes one or more said extension operations, the framework 110 will select (and then instruct) said extension driver to prepare execution of said one or more extension operations, and the reconstruction subroutine 104 in said extension driver will be triggered to run; otherwise, if the NN model does not include any said extension operation, said extension driver may not be selected and the reconstruction subroutine 104 may therefore not be triggered to run.

As shown in FIG. 1, the flow 200 according to the invention may include steps 202, 204 and 206. At step 202, before the model M1 is executed (e.g., when the app 100 is launched and initializes the model M1 to set it ready to be executed later), instead of directly revealing the model M1 to the framework 110 for instructing the HAL 120 to prepare execution of the model M1, the app 100 may call the modification subroutine 102 to run upon the model M1, and the modification subroutine 102 may modify the source model M1 to form a modified NN model M2 different from the model M1; then the app 100 may cause the framework 110 to accept the modified model M2 as the model to be executed, so the framework 110 may instruct the HAL 120 to prepare execution of the modified model M2. In other words, although the actual model to be executed is the source model M1, the app 100 may reveal the modified model M2, instead of the source model M1, to the framework 110, and may therefore deceive the framework 110 to treat the modified model M2 as the model to be executed. By step 202, the source model M1 will not be exposed to the framework 110, and therefore confidentiality of the source model M1 may be securely protected against peeking of the framework 110.

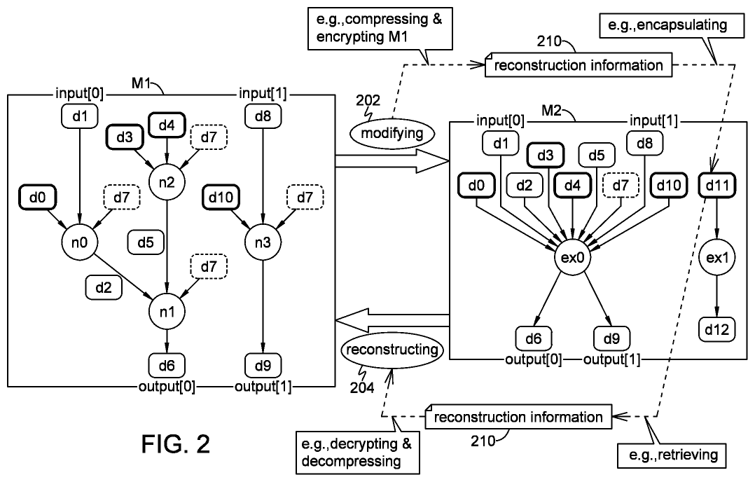

To demonstrate modifying performed by the modification subroutine 102 at step 202 according to an embodiment of the invention, FIG. 2 depicts an example of the source model M1 and the resultant modified model M2. As shown in FIG. 2, the model M1 may include one or more operations, such as n0 to n3, and one or more operands, such as d0 to d10. Each of the operands (e.g., d0 to d10) may be a scalar or a tensor, and may be associated with one or more of the operations (e.g., n0 to n3) as an input and/or an output of said one or more associated operations. In the example shown in FIG. 2, the operands d0, d1 and d7 may be inputs of the operation n0, and the operand d2 may be an output of the operation n0; the operands d3, d4 and d7 may be inputs of the operation n2, and the operand d5 may be an output of the operation n2; the operands d2, d5 and d7 may be inputs of the operation n1, and the operand d6 may be an output of the operation n1; the operands d7, d8 and d10 may be inputs of the operation n3, and the operand d9 may be an output of the operation n3. Moreover, a subset (one or more) of the operands (e.g., d0 to d10) of the model M1 may be input(s) of the model M1 and another subset (one or more) of the operands may be output(s) of the model M1; in the example shown in FIG. 2, the operands d1 and d8 may be two inputs input[0] and input[1] of the model M1, and the operands d6 and d9 may be two outputs output[0] and output[1] of the model M1. Each of the operations (e.g., n0 to n3) of the model M1 may calculate its output(s) in response to its input(s); for example, each operation may be an element-wise mathematical operation, a tensor manipulation operation, an image operation, a lookup operation, a normalization operation, a convolution operation; a pooling operation; an activation operation or an operation other than aforementioned operations.

The operands (e.g., d0 to d10) of the model M1 may include one or more learned operands; in the example shown in FIG. 2, the operands d0, d3, d4 and d10 may be learned operands. For example, each learned operand may be a learned weight or bias, etc. Each learned operand may include one or more learned parameters (not shown); for example, a learned operand may be a tensor containing multiple elements, and each element may be a learned parameter. Value of each learned parameter may be a k constant.

At step 202, modifying the model M1 to the model M2 may include one or more modifying actions, such as (a) to (g) discussed below. The modifying action (a) may include: when forming the model M2 from the model M1, discarding a subset (e.g., none, one, some or all) of the operations of the model M1. For example, as shown in FIG. 2, when forming the model M2, the original operations n0 to n3 of the model M1 may be discarded, so these operations of the model M1 may no longer exist in the model M2.

The modifying action (b) may include: when forming the model M2 from the model M1, causing the model M2 to include a subset (none, one, some or all) of the operands of the model M1, clearing value of each learned parameter of each learned operand of the model M1, and/or re-dimensioning each learned operand of the model M1 to be a scalar in the model M2. For example, as shown in FIG. 2, when forming the model M2, the model M2 may keep the operands d0 to d10 of the model M1 including the learned operands d0, d3, d4 and d10 but each learned parameter of the learned operands d0, d3, d4 and d10 may be cleared (e.g., be reset to zero or any random number) in the model M2; and/or, each of the learned operands d0, d3, d4 and d10 may be re-dimensioned to be a scalar in the model M2, even if anyone of the operands d0, d3, d4 and d10 is originally a tensor in the model M1. In other words, while the model M2 may keep a subset of the operands of the model M1, sensitive information regarding the learned operand(s) of the model M1, including value of each learned parameter and data structure (e.g., tensor dimension), may be erased when forming the model M2 from the model M1.

The modifying action (c) may include: generating a reconstructing information 210 which may indicate how to reconstruct the source model M1 from the modified model M2, encapsulating the reconstructing information 210 into a subset (one or more) of one or more additional operands, adding one or more said extension operations to the model M2, adding said one or more additional operands to the model M2, and arranging each of said one or more additional operands to be an input or an output of one of said one or more extension operations. For example, as shown in FIG. 2, when forming the model M2, two extension operations ex0 and ex1 tailored for the invention may be added to the model M2, two additional operands d11 and d12 may be added to the model M2, the reconstruction information 210 may be encapsulated to the additional operand d11, and the additional operands d11 and d12 may respectively be arranged to be an input and an output of the extension operation ex1. In an embodiment, generating the reconstructing information 210 may include: compressing the model M1 (including topology and learned parameters) to a model file (not shown) of a proprietary file format, and encrypting the model file by an encryption algorithm to form the reconstructing information 210; the encryption algorithm may be based on advanced encryption standard (AES) or secure hash algorithm (SHA), etc. In an embodiment, encapsulating the reconstruction information 210 into the subset (e.g., d11 in FIG. 2) of said one or more additional operands may include; sectioning the reconstruction information 210 to multiple data units (not shown), and arranging each of the data units to be an element of the subset of said one or more additional operands; for example, as shown in FIG. 2, if the reconstruction information 210 has NO bytes, then the NO bytes may be sectioned to, e.g., NO data units (with one byte per data unit); the additional operand d11 may therefore be a tensor of NO elements, and the NO data units may respectively be the NO elements of the additional operand d11.

As previously described, while the model M1 may include one or more operations and one or more operands, said one or more operands of the model M1 may include one or more operation-input operands and one or more model-output operands; moreover, said one or more operation-input operands may include one or more model-input operands, wherein said one or more operation-input operands may respectively be one or more inputs of said one or more operations of the model M1, said one or more model-input operands may respectively be one or more inputs of the model M1, and said one or more model-output operands may respectively be one or more outputs of the model M1. For example, as shown in FIG. 2, among the operands d0 to d10 of the model M1, the operands d0 to d5, d7, d8 and d10 may be referred to as operation-input operands of the model M1 since they are inputs of the operations n0 to n3, the operands d1 and d8 may be referred to as model-input operands of the model M1 since they are inputs of the model M1, and the operands d6 and d9 may be referred to as model-output operands of the model M1 since they are outputs of the model M1. Based on the modifying action (c), the modifying action (d) may include: when forming the model M2 from the model M1, rearranging said one or more operation-input operands of the model M1 to be one or more inputs of a first subset (one or more) of said one or more extension operations of the model M2. For example, as shown in FIG. 2, when forming the model M2, the operation-input operands d0 to d5, d7, d8 and d10 of the model M1 may be rearranged to be inputs of the same extension operation ex0 in the model M2, even though the operands d0 to d5, d7, d8 and d10 may originally be inputs of different operations n0 to n3 in the model M1. The modifying action (e) may include: when forming the model M2 from the model M1, rearranging said one or more model-output operands of the model M1 to be one or more outputs of said first subset of said one or more extension operations. For example, as shown in FIG. 2, when forming the model M2, the model-output operands d6 and d9 in the model M1 may be rearranged to be two outputs of the extension operation ex0 in the model M2, even though the operands d6 and d9 may originally be outputs of different operations in the model M1.

The modifying action (f) may include: when forming the model M2 from the model M1, rearranging said one or more model-input operands of the model M1 to be one or more inputs of the model M2. For example, as shown in FIG. 2, when forming the model M2 from the model M1, the operands d1 and d8, which originally are two inputs of the model M1, may also be two inputs of the model M2. In an embodiment, when rearranging said one or more model-input operands of the model M1 to be one or more inputs of the model M2, data structure (e.g., tensor dimension) of each of said one or more model-input operands may be kept unchanged. For example, as shown in FI. 2, the model-input operand d1 of the model M1 may be a tensor of a dimension [D1, D2, D3] in the model M1, and may remain to be a tensor of the dimension [D1, D2, D3] in the model M2.

The modifying action (g) may include: when forming the model M2 from the model M1, rearranging said one or more model-output operands of the model M1 to be one or more outputs of the model M2. For example, as shown in FIG. 2, when forming the model M2 from the model M1, the operands d6 and d9, which originally are two outputs of the model M1, may also be two outputs of the model M2. In an embodiment, when rearranging said one or more model-output operands of the model M1 to be one or more outputs of the model M2, data structure (e.g., tensor dimension) of each of said one or more model-output operands may be kept unchanged.

Modifying the model M1 to the model M2 at step 202 may include modifying actions other than the aforementioned modifying actions (a) to (g). For example, a modifying action may include: when forming the model M2, shuffling an order of learned parameters in a learned operand of the model M1 to form a modified operand of the model M2, and including reverse-shuffling information in the reconstruction information 210 when generating the reconstruction information 210, wherein the reverse-shuffling information may indicate how to reshuffle an order of parameters in the modified operand to recover the original learned operand from the modified operand. In general, modifying the model M1 to the model M2 may include any number of any kind of modifying action, as long as the resultant modified model M2 is different from the source model M1, and includes at least one said extension operation and at least one operand (e.g., d11 in FIG. 2) for recording the reconstruction information 210.

As shown in FIG. 1, by modifying the model M1 to the different model M2 with said extension operation(s) and causing the framework 110 to treat the model M2 as the model to be executed at step 202, the framework 110 will instruct the HAL 120 to prepare execution of the model M2, unaware of that the model to be executed is actually the model M1. Dumping information of the framework 110 will only expose the modified model M2, not the actual source model M1. Hence, confidentiality of the source model M1 may be effectively protected from undesired exposure to the framework 110.

At step 204, when the framework 110 instructs the HAL 120 to prepare execution of the model M2, because the model M2 includes said extension operation(s) (e.g., ex0 and ex1 in FIG. 2), the reconstruction subroutine 104 may be triggered to run, and may therefore reconstruct the source model M1 from the modified model M2 according to the reconstruction information 210 (FIG. 2). Accordingly, at step 206, the HAL 120 may then prepare execution of the model M1 by compiling the reconstructed model M1, and may execute the compiled model M1 when the framework 110 later requests the HAL 120 to execute the model M2. In other words, when the app 100 needs to initialize or execute the model M1, although the framework 110 will instruct or request the HAL 120 to prepare or execute the model M2 (since the framework 110 treats the model M2 as the model to be executed), the HAL 120 will correctly prepare (compile) or execute the model M1.

As previously discussed, in an embodiment, modifying the model M1 to the model M2 at step 202 may include: forming the reconstruction information 210 by compressing and encrypting the model M1, encapsulating the reconstructing information 210 into a subset (e.g., d11 in FIG. 2) of additional operand(s) (e.g., d11 and d12) by sectioning the reconstruction information 210 to data units as elements of the subset of the additional operand(s), and adding said extension operation(s) (e.g., ex0 and/or ex1 in FIG. 2) and the additional operand(s) (e.g., d11 and/or d12) to the model M2. Correspondingly, reconstructing the model M2 from the modified model M1 at step 204 may include: identifying said extension operation(s) and accordingly obtaining the additional operand(s), retrieving the reconstructing information 210 from the subset (e.g., d11) of the additional operand(s) by concatenating elements of the subset of the additional operand(s), and building the source model M1 according to the retrieved reconstruction information 210 by decrypting and decompressing the reconstruction information 210 to obtain the source model M1.

As previously mentioned, each said extension operation may be tailored to be a signature of the modification at step 202; in addition, each said extension may further be designed to facilitate the reconstruction at step 204. In the example shown in FIG. 2, the extension operation ex0 may be predefined as a dummy operation for maintaining indices of operands and model input-output mapping of the model M1. In an embodiment, when modifying the model M1 to the model M2 at step 202, all the operands d0 to d10 of the model M1 may be rearranged to be operands of the extension operation ex0, with indices of these operands kept unchanged in the model M2, and input-output mapping also kept unchanged. For example, the operand d0 may originally be indexed as a zeroth operand of the model M1, and may still be indexed as a zeroth operand of the model M2; the operands d1 and d8 originally mapped to two inputs input[0] and input[1] of the model M1 may remain mapped to two inputs input[0] and input [1] of the model M2, and the operands d6 and d9 originally mapped to two outputs output[0] and output[1] of the model M1 may remain mapped to two outputs output[0] and output[1] of the model M2. Therefore, when reconstructing the model M1 from the model M2 at step 204, the reconstruction subroutine 104 (FIG. 1) may identify all operands and indices of these operands by identifying inputs and outputs of the extension operation ex0, and may also identify the model input-output mapping of the model M1.

In the example shown in FIG. 2, the extension operation ex1 may be predefined as another dummy operation for storing the reconstruction information 210; for example, when modifying the model M1 to form the model M2 at step 202, the reconstruction information 210 may be encapsulated into the input operand d11 of the extension operation ext. Hence, when reconstruction the model M1 from the model M2 at step 204, the reconstruction subroutine 104 may identify the extension operation ex1 in the model M2 and then retrieve the reconstruction information 210 from the input of the extension operand ex1.

It is noted that secure model handling flow 200 according to the invention may also provide flexibility for developer. For example, when the app 100 is launched, the app 100 may be designed to determine if the manufacturer of the equipment is trustable (e.g., by looking up a whitelist of trustable manufactures) before initializing the source model M1; if trustable, a direct flow may be utilized: when initializing the model M1, the app 100 may not call the modification subroutine 102 to modify the model M1 and may directly reveal the model M1 to the framework 110, so the framework 110 will instruct the HAL 120 to prepare execution of the model M1; because the model M1 is not modified and therefore does not contain any said extension operation, the model M1 will not trigger the reconstruction subroutine 104 to run, and the HAL 120 may directly prepare execution of the model M1. On the other hand, if the app 100 determines that the manufacturer of the equipment 10 is not trustable, then the secure flow 200 of the invention may be utilized: when initializing the model M1, the app 100 may call the modification subroutine 102 to modify the model M1 to the model M2 and deceive the framework 110 to accept the model M2 as the one to be executed, so the framework 110 will instruct the HAL 120 to prepare execution of the model M2; because the model M2 contains said extension operation(s) added during modification, the model M2 will trigger the reconstruction subroutine 104 to run and reconstruct the model M1 from the model M2, and the HAL 120 may correctly prepare execution of the model M1.

And/or, the app 100 may also include another source NN model M1p (not shown) which is already publicly known, so the direct flow may be utilized when handling the model M1p, while the secure flow 200 of the invention may be utilized when handling the model M1 For example, when the app 100 initializes the models M1 and M1p, the app 100 may be designed to call the modification subroutine 102 to modify the model M1 to M2 but to leave the model M1p unmodified, and may then cause the framework 110 to treat the models M2 and M1p as two models to be executed, so the framework 110 will instruct the HAL 120 to prepare execution of the models M2 and M1p; the model M2 will trigger the reconstruction subroutine 104 to reconstruct the model M1 from the model M2, but the model M1p will not trigger the reconstruction subroutine 104 to run. The HAL 120 may then prepare execution of the models M1 and M1p.

To sum up, by coordinating app and HAL, the invention may provide a secure mechanism for protecting confidentiality of a source NN model against peeking of framework; when initializing the source NN model to be executed; by modifying the source NN model to a different modified NN model and causing the framework to accept the modified NN model as the model to be executed; the source NN model may not be exposed to the framework; and, when the framework instructs the HAL to prepare execution of the modified NN model, by reconstructing the source NN model from the modified NN model, the HAL may still correctly prepare (and execute) the source NN model.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method applied to an equipment for improving confidentiality protection of neural network model; an operating system of the equipment comprising a framework and a hardware abstraction layer (HAL), and the method comprising:
before a source model in an application (app) is executed, by a processor of the equipment, modifying the source model to form a modified model by running a modification subroutine associated with the app; and
causing the framework to accept the modified model, instead of the source model, as the model to be executed, so the framework instructs the HAL to prepare execution of the modified model.

2. The method of claim 1 further comprising:
when the framework instructs the HAL to prepare execution of the modified model, reconstructing the source model from the modified model by running a reconstructing subroutine in the HAL.

3. The method of claim 2 further comprising:
when the framework requests the HAL to execute the modified model, causing the HAL to execute the reconstructed source model.

4. The method of claim 1, wherein modifying the source model to form the modified model comprises:
generating a reconstructing information which indicates how to reconstruct the source model from the modified model;
encapsulating the reconstructing information into a subset of one or more additional operands;
adding one or more extension operations to the modified model; and
adding said one or more additional operands to the modified model.

5. The method of claim 4, wherein generating the reconstructing information comprises:
compressing and encrypting the source model to form the reconstructing information.

6. The method of claim 5 further comprising:
when the framework instructs the HAL to prepare execution of the modified model, reconstructing the source model from the modified model by:
retrieving the reconstruction information from the modified model; and
decrypting and decompressing the reconstruction information to obtain the source model.

7. The method of claim 4 further comprising:
when the framework instructs the HAL to prepare execution of the modified model, reconstructing the source model from the modified model;
wherein reconstructing the source model from the modified model comprises:
identifying said one or more extension operations and accordingly obtaining said one or more additional operands; and
retrieving the reconstructing information from said one or more additional operands, and building the source model according to the reconstruction information.

8. The method of claim 4 further comprising:
arranging each of said one or more additional operands to be an input or an output of one of said one or more extension operations.

9. The method of claim 4, wherein the source model comprises:
one or more original operations; and
one or more operation-input operands respectively being one or more inputs of said one or more original operations;
wherein modifying the source model to form the modified model further comprises:
rearranging said one or more operation-input operands to be one or more inputs of a first subset of said one or more extension operations.

10. The method of claim 9, wherein the source model further comprises one or more model-output operands respectively being one or more outputs of the source model, and modifying the source model to form the modified model further comprises:
rearranging said one or more model-output operands to be one or more outputs of the first subset of said one or more extension operations.

11. The method of claim 9, wherein said one or more operation-input operands comprise one or more learned operands, and modifying the source model to form the modified model further comprises:
re-dimensioning each of said one or more learned operands to be a scalar.

12. The method of claim 1, wherein the source model comprises one or more original operations, and modifying the source model to form the modified model comprises:
discarding a subset of said one or more original operations when forming the modified model from the source model.

13. A method applied to an equipment for improving confidentiality protection of neural network model; an operating system of the equipment comprising a framework and a HAL, and the method comprising:
when the framework instructs the HAL to prepare execution of a second model, by a processor of the equipment, causing the HAL to prepare execution of a first model different from the second model.

14. The method of claim 13 further comprising:
before the framework instructs the HAL to prepare execution of the second model, modifying the first model to form the second model.

15. The method of claim 13 further comprising:
when the framework instructs the HAL to prepare execution of the second model, reconstructing the first model from the second model before causing the HAL to prepare execution of the first model.

16. The method of claim 15, wherein the second model comprises one or more extension operations, and reconstructing the first model from the second model comprises:
identifying said one or more extension operations and accordingly obtaining one or more inputs of said one or more extension operations; and
retrieving a reconstructing information from aid one or more inputs, and building the first model according to the reconstruction information.

17. The method of claim 15, wherein the second model comprises one or more operands, and reconstructing the first model from the second model comprises:
retrieving a reconstructing information from a subset of said one or more operands, and decrypting and decompressing the reconstruction information to obtain the first model.

18. A method applied to an equipment for improving confidentiality protection of neural network model; an operating system of the equipment comprising a framework and a HAL, and the method comprising:
when the framework instructs the HAL to prepare execution of a second model, if the second model includes one or more extension operations, by a processor of the equipment, causing the HAL to prepare execution of a first model different from the second model; otherwise, causing the HAL to prepare execution of the second model.

19. The method of claim 18 further comprises:
when the framework instructs the HAL to prepare execution of a second model, if the second model includes said one or more extension operation, reconstructing the first model from the second model before causing the HAL to prepare execution of the first model.

20. The method of claim 19, wherein reconstructing the first model from the second model comprises:
obtaining a reconstructing information from one or more inputs of said one or more extension operations, and
building the first model according to the reconstruction information.
